(19) United States
(12) Patent Application Publication
(10) Pub. No.: US 2007/0166423 A1
(43) Pub. Date: Jul. 19, 2007

(54) Rubber and plastic mold adjustable date stamp insert

(76) Inventor: Daniel Bryant Tuck, East Liverpool, OH (US)

Correspondence Address: Daniel Tuck, 5 Highland Colony St., East Liverpool, OH, 43920, US

(21) Appl. No.: 11/333,660

(22) Filed: Jan. 18, 2006

(51) Int. Cl. B29C 59/00

(52) U.S. Cl. 425/385; 425/DIG. 47

(57) ABSTRACT

The purpose of a date code insert is to allow turning of indented data on the center piece to align and correlate with engravings on the outer ring to produce necessary identifications in the molded part as to material content, time of manufacture etc. It is also desired that the insert turn whenever and however required so as not to impede production by requiring maintenance or replacement. My product contains a groove(see FIG. 1a) for an o-ring on the bottom to control rotation if desired. My product also uses a single groove of specified size and location (see FIG. 1b) to control contaminant migration between the inserts and enable easy cleaning if necessary. This migration causes added turning force. This product also includes a slot to help free the insert should turning become difficult. These features eliminate the primary causes of failure of this type of product and leads to a product that can more likely operate for its desired functional life. Drawing MS08-DWG revision B details the dimensions necessary for the invention to work properly. These three features are what is claimed on the patent.

Many molded rubber products require a permanent means of traceability as to material type, time of manufacture or lot numbers for identification and recall if necessary. This is commonly done by a rotating insert placed inside an outer ring inserted into the face of the mold. On their top surfaces, many types of combinations of data can be engraved such that the impression becomes part of the molded part. Molding pressures, however, inevitably push material down the gap between them. These materials combined with heat and process liquids can be destructive to devices using mechanical fastening methods(i.e. threads). The unique features in this device control turning movement, limit and control material flash and allow for other non-destructive means to reliably turn the center. It can also be cleaned if necessary to enable continued productive use. This helps lead to a longer lasting and more useful product. Drawing MS08-DWG revision C shows the o-ring groove which is screwdriver slot Option A and B on the right side of the drawing. This feature is claim one in the application. The bottom left side view of the inner insert shows the 0.030″ diameter insert on the insert. Also shown in the Screwdriver Slot option section is the screwdriver slot itself. This is claim three of this application. This feature is claim two in the patent application.

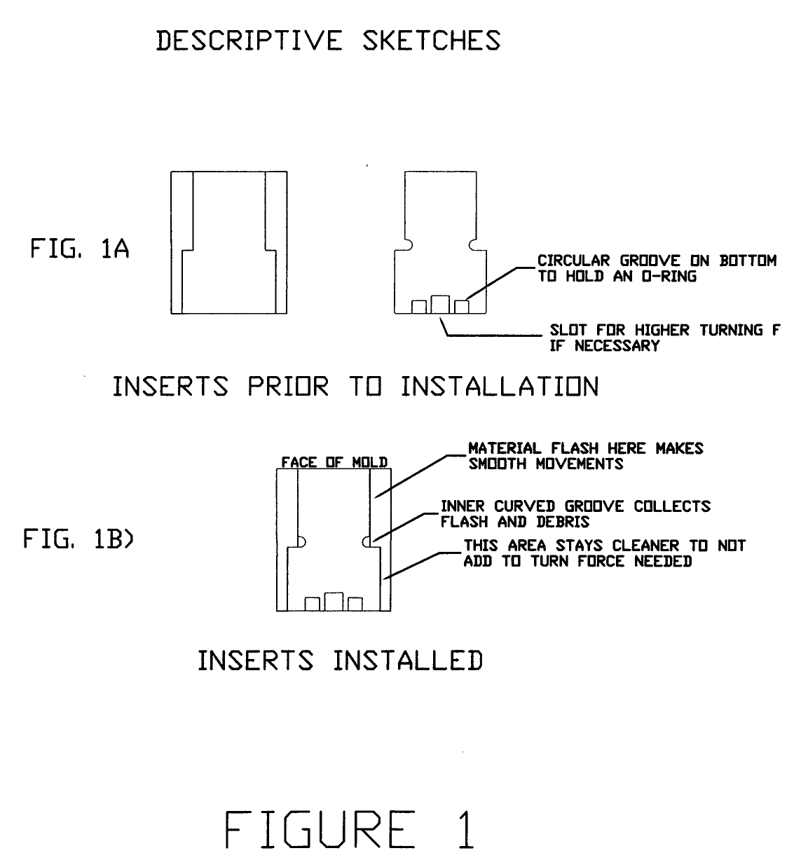

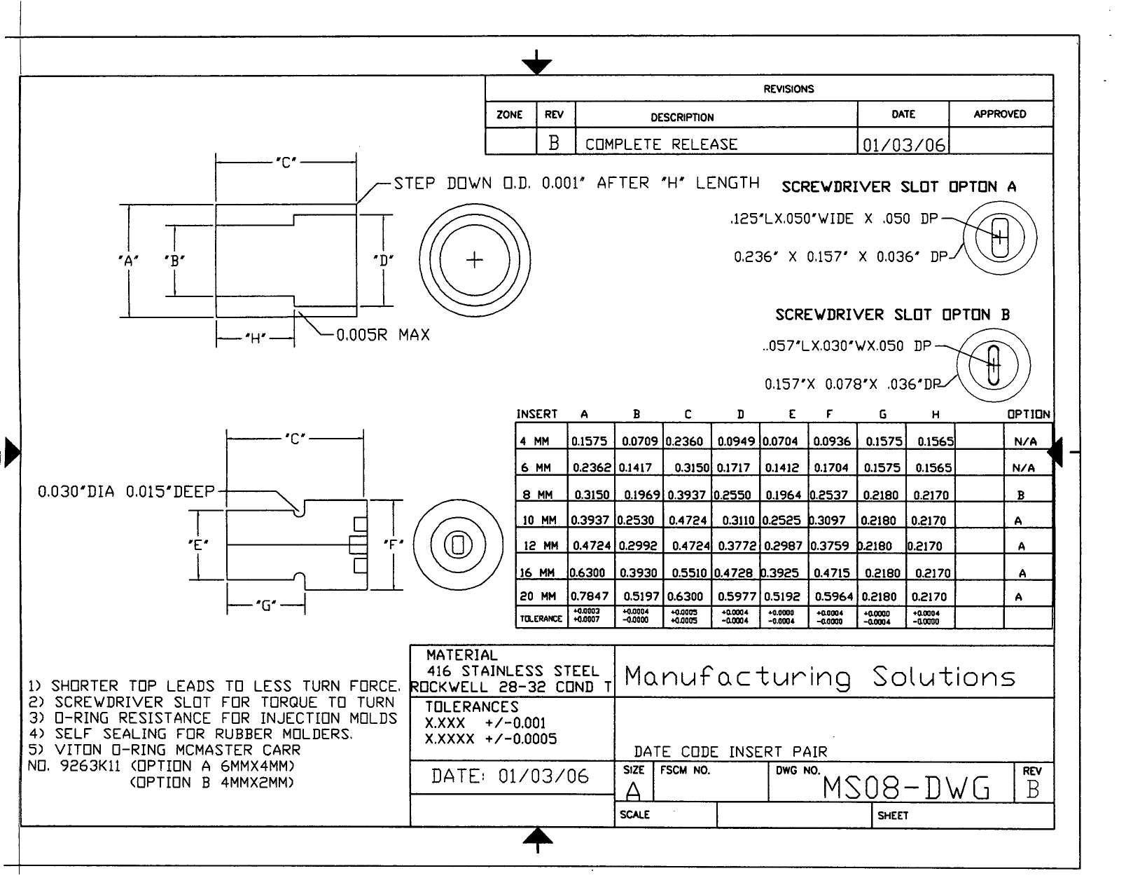

This section of the drawing shows the Drawing MS08-DWG has been updated for clarification in this specification only and it contains no new information with regards to the patent application. The second page drawing “DESCRIPTIVE SKETCHES” FIG. 1 schematically shows the two inserts assembled for greater clarity.

What is claimed is:

I) An o-ring groove machined in the bottom of the center rotating insert to help generate additional resistance to turning in the application and sealing of air flow when necessary.

II) A single inward curved relief on the center insert, at a specified distance from the top, to capture flash or fluids to keep the insert capable of performing its intended function longer. This also geometrically aids in taking them apart for cleaning should it become necessary.

III) A turn enabling slot in the bottom section to facilitate more torque if it does become stuck or restricted by debris.
